(19) United States
(12) Patent Application Publication
(10) Pub. No.: US 2025/0073648 A1
(43) Pub. Date: Mar. 6, 2025

(54) NANOFILTRATION MEMBRANE PREPARATION METHOD, AND NANOFILTRATION MEMBRANE PREPARED THEREBY

(71) Applicant: VONTRON TECHNOLOGY CO., LTD., Guiyang (CN)

(72) Inventors: Songmiao LIANG, Guiyang (CN); Lijie HU, Guiyang (CN); Geng LIU, Guiyang (CN); Peng SONG, Guiyang (CN); Jiajia ZHANG, Guiyang (CN); Binghui WANG, Guiyang (CN); Jibin WEN, Guiyang (CN)

(73) Assignee: VONTRON TECHNOLOGY CO., LTD., Guiyang (CN)

(21) Appl. No.: 18/711,491

(22) PCT Filed: Nov. 17, 2022
(86) PCT No.: PCT/CN2022/132633

§ 371 Date: May 17, 2024

(30) Foreign Application Priority Data
May 30, 2022 (CN) 202210600976.7

(51) Int. Cl. B01D 71/68; B01D 61/02; B01D 67/00; B01D 71/26; B01D 71/34; B01D 71/42

(52) U.S. Cl. CPC B01D 71/68; B01D 61/027; B01D 67/0011; B01D 67/0013; B01D 71/26; B01D 71/34; B01D 71/42; B01D 2325/48

(57) ABSTRACT

The present disclosure relates to a nanofiltration membrane preparation method, and a nanofiltration membrane prepared thereby. The preparation method comprises the following steps: preparing a casting solution, and curing the casting solution on a reinforcement material to form a base membrane; sequentially contacting the base membrane with a water phase solution and an oil phase solution so as to perform an interfacial polymerization reaction on the base membrane to form a polyamide functional layer, wherein the water phase solution includes a water phase monomer and an additive, the additive is a glycosylated sulfonamide compound, and the oil phase solution includes an oil phase monomer; and performing post-treatment to obtain a nanofiltration membrane, the post-treatment comprising hydroxylation treatment and crosslinking treatment. The nanofiltration membrane prepared by the preparation method of the present disclosure has high throughput and selective separation properties and excellent antibacterial properties, and can effectively prevent microbial pollution.

### TECHNICAL FIELD

The present disclosure relates to a technical field of water filtration membranes, and in particular, to a preparation method for a nanofiltration membrane and a nanofiltration membrane prepared by the same.

### BACKGROUND

With the development of economy, people's demand for printing, dyeing and textile is increasing gradually. In recent years, the production and use of dyes have greatly increased. In this process, a large amount of wastewater containing dyes will be generated. If the untreated wastewater containing dyes is discharged directly, it will lead to serious environmental pollution problems. Therefore, the treatment and recycling of dye-containing wastewater has become one of the environmental problems that need to be solved urgently. Besides, during the process of using dyes, a large number of inorganic salts will be added to improve the production and dyeing efficiency, which aggravates the difficulty of dye recovery. How to realize effective separation of reactive dyes from inorganic salts in dye-containing wastewater, to achieve recovery and reuse, is a key point of current research.

Membrane separation technology is a novel reliable separation technology, which has outstanding application performance in the fields of water treatment, pharmacy, food, energy and chemical industry, and has attracted the attention of researchers. Among them, nanofiltration membrane has been widely used in water treatment process. As compared with reverse osmosis membrane, nanofiltration membrane has been successfully applied often because of its selective separation of one solute. One is the separation of salt ions with different valence states. For example, in the softening process of groundwater, calcium and magnesium ions in water may be effectively removed and sodium ions may be retained through nanofiltration process, thereby effectively reducing the hardness of water. The other one is the separation of small organic molecules and salt ions. For example, in the textile industry, dye-containing wastewater usually contains dyes and salt substances. Through the nanofiltration process, the dyes may be intercepted and salt substances may be collected for secondary utilization, and the dyes may be further concentrated to a concentration that is easier to be treated. Therefore, nanofiltration membrane separation technology is the most economical and effective technology for treating wastewater in printing and dyeing industry at present.

In the practical application process of a nanofiltration membrane system, besides the interception performance of the nanofiltration membrane, it is also very important to consider the operating cost of the system. By increasing the water flux of the nanofiltration membrane, the operating pressure of the system may be effectively reduced, and the operating cost of the nanofiltration membrane system may be greatly decreased. Among the types of nanofiltration membranes, a nanofiltration membrane of a polyamide layer having a loose structure may effectively improve the permeation flux, which provides a good foundation for the practical application of the nanofiltration membrane.

At present, many researches have focused on how to prepare a nanofiltration membrane of a polyamide layer having a loose structure. For example, as mentioned in patent document CN111450715B, an inorganic salt is added in the preparation of a base membrane, and tannic acid is used as the water phase solution to prepare a nanofiltration membrane having a loose structure. In patent document CN112058094B, researchers add polyurea microspheres to a base membrane to cross-link the surface of the base membrane to prepare a nanofiltration membrane having a loose structure.

It should be noted that membrane pollution is the main obstacle to the application of membrane technologies such as nanofiltration membrane. Membrane pollution refers to the phenomenon of adsorption, deposition and blockage on the surface or in the pores of the membrane due to the physicochemical action or mechanical action between suspended substances or soluble substances (such as microorganisms, macromolecules and colloidal salts) and the membrane during the membrane filtration. The existence of membrane pollution will lead to attenuation of the membrane flux and reduction of the membrane life, which will increase the application cost of membrane separation technology. Reducing membrane pollution has become a key technical problem in the application of membrane separation technology.

Membrane pollution is mainly divided into organic pollution, inorganic pollution, microbial pollution and colloid pollution, wherein organic pollution and inorganic pollution are reversible pollution, while microbial pollution and colloid pollution are mainly irreversible pollution. Microbial contamination on the membrane surface may be attributed to the biological layer formed by the adsorption and reproduction of bacteria and algae on the membrane surface. In order to avoid pollution on the membrane surface, it is necessary to carry out antibacterial treatment on the membrane surface to alleviate the permanent decline of membrane performance caused by irreversible microbial pollution.

Therefore, how to prepare a nanofiltration membrane having good permeability, separation performance and anti-microbial pollution is a major technical hotspot in the current research of nanofiltration membranes.

### SUMMARY

### Technical Problem

To solve the above problems in the prior art, an object of the present disclosure is to provide a preparation method for a nanofiltration membrane and a nanofiltration membrane prepared by the same. The nanofiltration membrane has high flux and selective separation performance (selective separation of organic dyes and inorganic salts) as well as excellent antibacterial performance during water treatment process, and is capable of effectively avoiding microbial pollution.

### Solution to Problem

In order to achieve the above object, the inventors of the present disclosure conducted diligent research and discovered that by introducing a glycosylated sulfonamide substance into a water phase solution as an additive, the diffusion process of a water phase monomer in interfacial polymerization may be changed, which induces the formation of a polyamide functional layer having a loose structure, thereby improving the flux of the membrane, and meanwhile the introduction of the sulfonamide group may bring an antibacterial effect and reduce microbial pollution on the membrane surface; after the polyamide functional layer is formed by interfacial polymerization, it is subject to a post-treatment comprising hydroxylation treatment and crosslinking treatment, which is capable of ensuring performance stability of the nanofiltration membrane in a long-term operation process.

The present disclosure provides a preparation method for a nanofiltration membrane, comprising the following steps:
preparing a casting solution, and curing the casting solution on a reinforcement material to form a base membrane, wherein the casting solution contains a polymer and a solvent;
contacting the base membrane with a water phase solution and an oil phase solution in turn to perform an interfacial polymerization reaction on the base membrane to form a polyamide functional layer, wherein the water phase solution contains a water phase monomer and an additive which is a glycosylated sulfonamide compound, and the oil phase solution contains an oil phase monomer;
performing post-treatment to obtain a nanofiltration membrane, wherein the post-treatment comprises hydroxylation treatment and crosslinking treatment.

According to the preparation method of the present disclosure, wherein the polymer is at least one selected from polysulfone, polyethersulfone, sulfonated polyethersulfone, polyimide, polyvinylidene fluoride, polyacrylonitrile, polypropylene and polyvinyl chloride.

According to the preparation method of the present disclosure, wherein the glycosylated sulfonamide compound is obtained by glycosylation reaction between a saccharide compound and a compound containing a sulfonamide group, and preferably, the mass percentage concentration of the glycosylated sulfonamide compound is 0.001-1.0 wt. % based on the total mass of the water phase solution.

According to the preparation method of the present disclosure, wherein the saccharide compound is at least one selected from D-glucose, N-aryl glycoside, lactose, galactose, N-acetyl-D-glucosamine, arabinose, N-acetyl-D-galactosamine, D-ribose, L-rhamnose, xylose, mannose and maltose.

According to the preparation method of the present disclosure, wherein the compound containing a sulfonamide group is at least one selected from a compound represented by the following formula I and a compound represented by the following formula II:

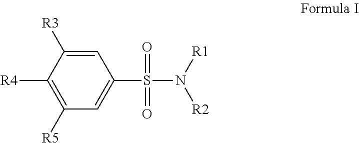

In formula I, R1 and R2 are at least one selected from H, hydrocarbon group having 1 to 5 carbon atoms, amino group and cyano group, R3, R4 and R5 are at least one selected from H, amino group, imino group and hydroxyl group, and at least one of R3, R4 and R5 is an amino group.

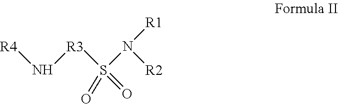

In formula II, R1 and R2 are hydrocarbon groups having 1 to 10 carbon atoms, which optionally contain at least one selected from amino group, cyano group, carboxyl group, double bond and ethynyl group, R3 is a hydrocarbon group having 1 to 5 carbon atoms, R4 is at least one selected from H and hydrocarbon group having 1 to 10 carbon atoms, the hydrocarbon group having 1 to 10 carbon atoms optionally containing at least one selected from hydroxyl group, carboxyl group, ketonic group, ether bond, carbonyl, imino, acyl and phenyl.

According to the preparation method of the present disclosure, wherein the water phase monomer is at least one selected from piperazine, 2-methylpiperazine, polyethyleneimine, m-phenylenediamine, p-phenylenediamine, o-phenylenediamine and benzene-1,3,5-triamine; preferably, the mass percentage concentration of the water phase monomer is 0.1-3.0 wt. % based on the total mass of the water phase solution.

According to the preparation method of the present disclosure, wherein the oil phase monomer is at least one selected from trimesoyl chloride, cyanuric chloride, dansyl chloride, isophthaloyl chloride, terephthaloyl chloride, phthaloyl chloride and biphenyl tetracarbonylchloride; preferably, the mass percentage concentration of the oil phase monomer is 0.05-1.0 wt. % based on the total mass of the oil phase solution.

According to the preparation method of the present disclosure, wherein the hydroxylation treatment is carried out in a solution containing an alcohol amine substance, preferably, the alcohol amine substance is at least one selected from diethanolamine and triethanolamine, and preferably, the mass percentage concentration of the alcohol amine substance is 0.5-5.0 wt. % based on the total mass of the solution containing the alcohol amine substance.

According to the preparation method of the present disclosure, wherein the crosslinking treatment is carried out in a solution containing a crosslinking agent which is a dialdehyde compound having 2 to 6 carbon atoms, and preferably, the mass percentage concentration of the crosslinking agent is 0.01-0.5 wt. % based on the total mass of the solution containing the crosslinking agent.

The present disclosure further provides a nanofiltration membrane prepared by the preparation method according to the present disclosure.

### Effects

By using the nanofiltration membrane prepared by the preparation method according to the present disclosure, which has a water flux as high as 80-120 L/(m²/h), the removal rates of Congo red, methyl orange and acid fuchsin may reach 99%, 82-90% and 90-95%, respectively, and the removal rate of magnesium sulfate may be adjusted to 30%, thereby realizing selective separation of organic dye molecules and inorganic salt ions. Besides, an excellent antibacterial performance is achieved, which effectively relieves microbial pollution on the surface of the membrane during operation. The preparation method provided by the disclosure is simple and easy to operate. The nanofiltration membrane may be applied to separation and concentration technologies in the fields of water treatment, dyes, biochemistry, food, environmental protection and the like.

### DETAILED DESCRIPTION

The present disclosure provides a preparation method for a nanofiltration membrane, comprising steps of:
preparing a casting solution, and curing the casting solution on a reinforcement material to form a base membrane, wherein the casting solution contains a polymer and a solvent;
contacting the base membrane with a water phase solution and an oil phase solution in turn to perform an interfacial polymerization reaction on the base membrane to form a polyamide functional layer, wherein the water phase solution contains a water phase monomer and an additive which is a glycosylated sulfonamide compound, and the oil phase solution contains an oil phase monomer;
performing post-treatment to obtain a nanofiltration membrane, wherein the post-treatment comprises hydroxylation treatment and crosslinking treatment.

The technical concept of the present disclosure is as follows: by introducing a glycosylated sulfonamide substance into a water phase solution as an additive, the diffusion process of a water phase monomer in interfacial polymerization reaction may be changed, which induces the formation of a polyamide functional layer having a loose structure, thereby improving the flux of the membrane, and meanwhile the introduction of the sulfonamide group may bring an antibacterial effect and reduce microbial pollution on the membrane surface; after the polyamide functional layer is formed by interfacial polymerization reaction, it is subject to a post-treatment comprising hydroxylation treatment and crosslinking treatment, which is capable of ensuring performance stability of the nanofiltration membrane in a long-term operation process.

According to the preparation method of the present disclosure, wherein the polymer is at least one selected from polysulfone, polyethersulfone, sulfonated polyethersulfone, polyimide, polyvinylidene fluoride, polyacrylonitrile, polypropylene and polyvinyl chloride.

Preferably, the mass percentage concentration of the polymer is 15wt. %- 25wt. % based on the total mass of the casting solution.

The solvent in the casting solution is not particularly limited as long as it is capable of fully dissolving the polymer. Preferably, the solvent is at least one of N,N-dimethylformamide (DMF), N,N-dimethylacetamide (DMAC), dimethyl sulfoxide, N-methylpyrrolidone, tetrahydrofuran and imidazolinone.

The casting solution optionally contains a non-solvent, and preferably, the non-solvent is at least one of alcohol having 1 to 6 carbon atoms, polyethylene glycol, polyvinylpyrrolidone, polypropylene glycol and polybutylene glycol. Examples of the alcohol having 1 to 6 carbon atoms include at least one of methanol, ethanol, n-propanol, isopropanol, n-butanol, isobutanol, tert-butanol, n-pentanol, isopentanol and hexanol. The non-solvent is preferably at least one of ethanol, n-propanol, isopropanol, n-butanol, polyethylene glycol, polypropylene glycol, polybutylene glycol and polyvinylpyrrolidone. Preferably, the mass percentage concentration of the non-solvent is 0.5-5wt. % based on the total mass of the casting solution.

The reinforcement material used in the present disclosure may be polypropylene (PP) nonwoven fabric, nylon (PA) nonwoven fabric, polyethylene (HDPE) nonwoven fabric and polyester (PET) nonwoven fabric.

The method of coating the casting solution on the nonwoven fabric is not particularly limited, and the coating methods commonly used in the field of nanofiltration membrane preparation may be used, such as casting method, dip coating method, blade coating method, spin coating method, etc., and the blade coating method is more preferred. After the coating on the nonwoven fabric, it is then immersed in a coagulation bath, so that the casting solution is solidified into a film.

The pore size of the base membrane is not particularly limited, and it is preferably 20-40 nm; the thickness of the base membrane is not particularly limited, and it is preferably 35 to 45 μm.

According to the preparation method of the present disclosure, the glycosylated sulfonamide compound is obtained by glycosylation reaction between a saccharide compound and a compound containing a sulfonamide group. The glycosylated sulfonamide compound simultaneously has some properties of saccharide substance and some properties of sulfonamide groups, which may change the diffusion process of polyamine monomer in the water phase solution during interfacial polymerization reaction and induces the formation of a polyamide functional layer having a loose structure, and meanwhile, the introduced sulfonamide group may bring an antibacterial effect in the subsequent application process.

According to the preparation method of the present disclosure, preferably, the mass percentage concentration of the glycosylated sulfonamide compound is 0.001-1.0 wt. %, more preferably 0.05-0.5 wt. %, based on the total mass of the water phase solution; if the concentration of the glycosylated sulfonamide compound is less than 0.001wt. %, the flux of the membrane will not increase significantly; if the concentration of the glycosylated sulfonamide compound is higher than 1.0 wt. %, it will lead to poor film-forming property.

According to the preparation method of the present disclosure, wherein the saccharide compound has a water-soluble property and is preferably at least one selected from D-glucose, N-aryl glycoside, lactose, galactose, N-acetyl-D-glucosamine, arabinose, N-acetyl-D-galactosamine, D-ribose, L-rhamnose, xylose, mannose and maltose.

According to the preparation method of the present disclosure, wherein the compound containing a sulfonamide group is at least one selected from a compound represented by the following formula I and a compound represented by the following formula II:

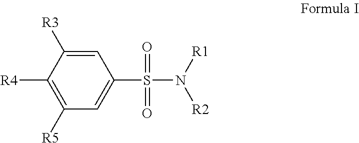

In formula I, R1 and R2 are at least one selected from H, hydrocarbon group having 1 to 5 carbon atoms, amino group and cyano group, examples of the hydrocarbon group having 1 to 5 carbon atoms including methyl, ethyl, isopropyl, etc., R3, R4 and R5 are at least one selected from H, amino group, imino group and hydroxyl group, and at least one of R3, R4 and R5 is an amino group.

Examples of the compound represent by formula I include p-aminobenzenesulfonamide, 3-aminobenzenesulfonamide, 5-amino-2-toluenesulfonamide, 4-aminomethylbenzenesulfonamide, 2-aminophenol-4-sulfonamide, 3,4-diaminobenzenesulfonamide, etc.

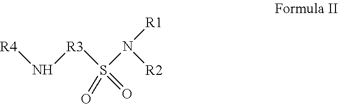

In formula II, R1 and R2 are hydrocarbon groups having 1 to 10 carbon atoms, which optionally contain at least one selected from amino group, cyano group, carboxyl group, double bond and ethynyl group, R3 is a hydrocarbon group having 1 to 5 carbon atoms, R4 is at least one selected from H and hydrocarbon group having 1 to 10 carbon atoms, the hydrocarbon group having 1 to 10 carbon atoms optionally containing at least one selected from hydroxyl group, carboxyl group, ketonic group, ether bond, carbonyl, imino, acyl and phenyl.

Examples of the compound represented by formula II include 2-aminoethyl sulfonamide, 2-anilino ethyl sulfonamide, 2-(2-phenylhydrazyl) ethyl sulfonamide, 2-(2-benzoylhydrazyl) ethyl sulfonamide, 2-(2-benzoylhydrazyl)-N-ethynyl ethyl sulfonamide, 2-(2-benzoylhydrazyl)-N-ethynyl-N-propyl ethyl sulfonamide, and 2-(2-benzoylhydrazyl)-N-benzyl-N-ethynyl ethyl sulfonamide, etc.

According to the preparation method of the present disclosure, wherein the water phase monomer is at least one selected from piperazine, 2-methylpiperazine, polyethyleneimine, m-phenylenediamine, p-phenylenediamine, o-phenylenediamine and benzene-1,3,5-triamine. 10)

Preferably, the mass percentage concentration of the water phase monomer is 0.1-3.0 wt. %, more preferably 0.5-1.5 wt. %, based on the total mass of the water phase solution. If the content of the water phase monomer is less than 0.1 wt. %, it will lead to a poor film-forming property, and the prepared nanofiltration membrane does not have a separation property; if the 15 content of the water phase monomer is higher than 3.0 wt. %, the prepared nanofiltration membrane has a quite thick polyamide functional layer, which seriously increases the mass transfer resistance of water molecules and leads to poor membrane performance.

The water phase solution may optionally contain a pH regulator to adjust the pH value of the solution to a range of 9 to 12, thereby facilitating the interfacial polymerization reaction. The pH regulator may be at least one selected from sodium hydroxide, potassium hydrogen phosphate, potassium hydroxide, sodium carbonate and triethylamine/camphorsulfonic acid. The combination of triethylamine and camphorsulfonic acid is used to adjust pH, which may make the reaction relatively mild and is a common pH adjustment collocation in interfacial polymerization reaction.

The time and temperature of the contact between the base membrane and the water phase solution are not particularly limited, and it is preferable to contact for 10 to 60 seconds at a temperature within 15 to 45°° C.

According to the preparation method of the present disclosure, wherein the oil phase monomer is at least one selected from trimesoyl chloride, cyanuric chloride, dansyl chloride, isophthaloyl chloride, terephthaloyl chloride, phthaloyl chloride and biphenyl tetracarbonylchloride.

Preferably, the mass percentage concentration of the oil phase monomer is 0.05-1.0 wt. %, more preferably 0.1-0.5 wt. %, based on the total mass of the oil phase solution. If the content of the oil phase monomer is less than 0.05wt. %, it is impossible to form a polyamide functional layer to meet the performance requirement of the nanofiltration membrane; if the content of the oil phase monomer is higher than 1.0 wt. %, the prepared nanofiltration membrane will have seriously decreased flux, or even have no flux.

The solvent in the oil-phase solution is not particularly limited, and examples thereof may include n-hexane, n-heptane, cyclohexane, ethyl cyclohexane, Isopar M, Isopar H, Isopar L, Isopar E, Isopar G and the like.

The time and temperature of the contact between the base membrane and the oil phase solution are not particularly limited, and it is preferable to contact for 10 to 60 seconds at a temperature within 15 to 45° C.

According to the preparation method of the present disclosure, preferably, after contacting with the water phase solution and the oil phase solution in turn to carry out interfacial polymerization reaction, heating may be carried out to further crosslink the polyamide functional layer, preferably, the heating temperature being within a range of 25-40° C., and the heating time is 1-5 minutes. The purpose of heating is to further promote volatilization of the solvent and the crosslinking and curing of the polyamide functional layer. If the heating temperature is too high or the heating time is too long, the microstructure on the membrane surface will be torn, which reduces desalination performance of the membrane.

According to the preparation method of the present disclosure, the post-treatment comprises hydroxylation treatment and crosslinking treatment, the hydroxylation treatment referring to hydroxylation of the oil-phase monomer that has not undergone interfacial polymerization reaction in the oil-phase solution, wherein the hydroxylation treatment is carried out in a solution containing an alcohol amine substance; preferably, the alcohol amine substance is at least one selected from diethanolamine and triethanolamine, and the function thereof is to induce the acyl chloride group of the acyl chloride monomer that has not participated in the interfacial polymerization reaction to carry out hydroxylation modification, thereby introducing hydroxyl groups on the surface of the membrane.

In the treatment, the alcohol amine substance is covalently bonded to unreacted acyl chloride groups, so that amino groups in alcohol amine have participated in reaction, leaving hydroxyl groups on the membrane surface, thereby enhancing the hydrophilicity of the membrane surface, alleviating the pollution of the membrane during long-term operation, and reducing the degradation of the membrane performance caused by pollution.

At the same time, because the reactivity of glycosylated sulfonamide compound in the water phase solution is lower than that of the water phase monomer, the glycosylated sulfonamide compound is not bonded to the polyamide functional layer via chemical bonds, and the glycosylated sulfonamide compound will fall off during the long-term operation of the membrane, which will damage the antibacterial stability of the membrane. By introducing hydroxyl groups into the surface of the membrane, the glycosylated sulfonamide compound existing in the membrane is combined with the hydroxyl groups on the surface of the membrane under the action of a crosslinking agent, and is fixed in the polyamide functional layer by chemical bonding, thus ensuring the antibacterial stability of the membrane during use.

Preferably, the mass percentage concentration of the alcohol amine substance is 0.5-5.0 wt. %, based on the total mass of the solution containing the alcohol amine substance. When the concentration is within this range, the oil-phase monomer (acyl chloride monomer) that has not undergone interfacial polymerization reaction may not be completely hydroxylated, and the non-hydroxylated acyl chloride monomer is hydrolyzed to generate carboxyl groups, so that the surface of the membrane is negatively charged and repulsive to negatively charged dyes and inorganic salts, thereby promoting the interception of dyes and inorganic salts. More preferably, the mass percentage concentration of the alcohol amine substance is 1.0-3.0 wt. %.

Further preferably, it is immersed in a solution containing the alcohol amine substance for 0.5 to 5 minutes at a temperature in the range of 40 to 60° C.

The solution containing the alcohol amine substance may optionally contain a pH regulator to adjust the pH value of the solution to a range of 9 to 11, which is more conducive to the reaction. The pH regulator may be at least one selected from sodium hydroxide, potassium hydrogen phosphate, potassium hydroxide, sodium carbonate and triethylamine/camphorsulfonic acid.

According to the preparation method of the present disclosure, the crosslinking treatment is carried out in a solution containing a crosslinking agent. In this treatment, the hydroxyl groups left on the surface of the membrane through the hydroxylation modification are further crosslinked and fixed with the hydroxyl groups and amino groups of the glycosylated sulfonamide compound under the action of the crosslinking agent, so that the glycosylated sulfonamide compound stably exists in the polyamide functional layer to ensure the stable performance of the membrane in a long-term operation process.

Preferably, the crosslinking agent is a dialdehyde compound having 2 to 6 carbon atoms. Examples include glyoxal, malondialdehyde, butyraldehyde and glutaraldehyde, etc.

Preferably, the mass percentage concentration of the crosslinking agent is 0.01-0.5 wt. %, more preferably 0.02-0.1 wt. %, based on the total mass of the solution containing the crosslinking agent.

Preferably, the immersion time in the solution containing the crosslinking agent is 1 to 5 minutes, more preferably 2 to 4 minutes. The purpose of this process is mainly to further gain and ensure the performance of the nanofiltration membrane. If the concentration of the crosslinking agent is too low or the immersion time is insufficient, the expected effect may not be achieved, and if the concentration of the crosslinking agent is too high or the immersion time is too long, the overall performance of the membrane will also be reduced.

According to the preparation method of the present disclosure, preferably, the post-treatment may also comprise two-stage water washing, the temperature of water washing in the first stage being 40-60°° C., and the temperature of water washing in the second stage being 20-30° C., so as to wash away residues of the previous process, such as unreacted amine monomer, acyl chloride monomer, glycosylated sulfonamide compound, and the crosslinking agent.

Preferably, a protective layer solution is then coated on the surface of the nanofiltration membrane, the protective layer solution containing a polyhydroxy polymer, such as polyvinyl alcohol, polyethylene glycol and the like. The function of the protective layer solution is to reduce the damage of nanofiltration membrane surface during subsequent heating and drying treatment and to ensure the stability of membrane structure. Preferably, the content of the polyhydroxy polymer is 1-3 wt. %, more preferably 1.5-2.5 wt. %, based on the total mass of the protective layer solution, and further preferably, the coating time is 5-20 seconds.

The protective layer solution may optionally contain at least one selected from hydrochloric acid and glutaraldehyde, wherein the hydrochloric acid is added mainly to adjust the pH value of the solution and promote the dissolution of the polyhydroxy polymer such as polyvinyl alcohol and polyethylene glycol, and the addition of a small amount of glutaraldehyde may promote the self-crosslinking of the polyhydroxy polymer such as polyvinyl alcohol and polyethylene glycol, so that a protective layer may be better formed during coating.

Preferably, heating and drying process is performed to obtain the final nanofiltration membrane. Preferably, the temperature for the heating and drying is within a range of 50 to 90° C., and the drying time is 1 to 3 minutes.

As the preparation method of nanofiltration membrane according to the present disclosure, there are the following non-limiting examples:

Polysulfone or polyethersulfone (15-25wt. %) as a polymer is dissolved in dimethylformamide (DMF) or dimethylacetamide (DMAC), and 2 wt. % polyethylene glycol 400 is optionally added, it is stirred at 60° C. for 6 hours until the polymer is completely dissolved, followed by standing for defoaming; the casting solution on a nonwoven fabric forms a base membrane through liquid-solid phase transformation.

The prepared base membrane is immersed in a water phase solution containing 0.1-3.0 wt. % water phase monomer, 0.001-1.0 wt. % glycosylated sulfonamide compound and 0-0.1 wt. % sodium hydroxide, and then the water droplets on the surface are drained.

Next, the membrane is immersed in an oil phase solution containing 0.05-1.0 wt. % acyl chloride monomer, and then the solution on the surface is drained.

Next, the membrane is immersed in an aqueous solution containing 0.1-5.0 wt. % diethanolamine and an aqueous solution containing 0.01-0.5 wt. % crosslinking agent, in turn.

After the membrane is taken out, it is washed with pure water, coated with a protective layer solution, and then dried, to prepare a nanofiltration membrane having a loose structure and an antibacterial functional layer.

The present disclosure further provides a nanofiltration membrane prepared by the preparation method according to the present disclosure. The nanofiltration membrane prepared by the preparation method of the present disclosure has a water flux as high as 80-120 L/(m²/h), the removal rates of Congo red, methyl orange and acid fuchsin may reach 99%, 82-90% and 90-95%, respectively, and the removal rate of magnesium sulfate may be adjusted to 30%, thereby realizing selective separation of organic dye molecules and inorganic salt ions. Besides, the nanofiltration membrane has an excellent antibacterial performance, which effectively relieves microbial pollution on the surface of the membrane during operation. The nanofiltration membrane may be applied to separation and concentration technologies in the fields of water treatment, dyes, biochemistry, food, environmental protection and the like.

### EXAMPLES

The following examples are described to further describe the present disclosure in detail, rather than a limitation to the present disclosure. It should be noted that the reagents and raw materials used in the examples of the present disclosure are all commercially available conventional products unless otherwise specified.

### Preparation Example

### Synthesis of Glycoside Sulfonamide Compound

### (1) Synthesis of Glycoside Sulfonamide Compound Represented by Formula I

28.4 g of disodium hydrogen phosphate was weighed and dissolved in 100 ml of water, which was diluted to 1000 ml by water for later use; 24 g of sodium dihydrogen phosphate was weighed and dissolved in 100 ml of water, which was diluted to 1000 ml by water for later use; 68.5 ml of the aqueous solution of sodium dihydrogen phosphate and 31.5 ml of the aqueous solution of disodium hydrogen phosphate were measured and put in a beaker, and mixed evenly to prepare a phosphate buffer solution having a pH value of 6.5 for later use.

4.3 g of 3-aminobenzenesulfonamide was weighed and put in the phosphate buffer solution, which was heated to 40°° C., and then 4.5 g of glucose was added slowly while being stirred; the stirring was performed for 5 hours at a constant temperature of 40° C. until the reaction became stable; the reactant was purified by high performance liquid chromatography. C18 was used as a reverse column, acetonitrile/water (at a ratio of 15/85 (v/v)) was used as a mobile phase, and the flow rate was 5 ml/min. Elution and separation were carried out at room temperature, and the separated liquid was freeze-dried, to obtain a white crystal, i.e., compound 1-1.

The above 3-aminobenzenesulfonamide was replaced with p-aminobenzenesulfonamide, 2-aminophenol-4-sulfonamide and 4-amino-N-methylbenzenesulfonamide, respectively, to synthesize compounds 1-2, 1-3 and 1-4, respectively.

The above glucose was replaced with N-aryl glycoside, N-acetyl-D-glucosamine and N-acetyl-D-galactosamine, respectively, to synthesize compounds 1-5, 1-6 and 1-7, respectively.

### (2) Synthesis of Glycoside Sulfonamide Compound Represented by Formula II

5.9 g of n-propylamine, 30.3 g of triethylamine and 13.5 g of dichloromethane were weighed and put into a 100 ml flask, which was placed in an ice bath environment, and 24.5 g of 2-chloroethyl sulfonyl chloride was added slowly while being stirred, followed by reaction at room temperature for 2 hours. Extraction was performed with water and dichloromethane, the organic phase solution was vacuum-dried by a rotary evaporator, then separated by a liquid chromatography silica gel column, and eluted and separated at room temperature with petroleum ether/ethyl acetate (at a ratio of 80/20 (v/v)) as a mobile phase at a flow rate of 5 ml/min, to obtain an intermediate compound A after purification.

2.1 g of the obtained compound A was weighed and dissolved in 7.9 g of acetonitrile, 12.5 g of 3-bromopropyne and 27 g of potassium carbonate were added in turn during the stirring process. The mixture was heated in an oil bath environment (comprising a reflux device) at 95° C. to react for 5-6 hours, and then the mixed liquid was taken out and subject to suction filtration. The obtained liquid was vacuum-dried by a rotary evaporator, then separated by a liquid chromatography silica gel column, and eluted and separated at room temperature with petroleum ether/ethyl acetate (at a ratio of 90/10 (v/v)) as a mobile phase at a flow rate of 5 ml/min, to obtain an intermediate compound B after purification.

### (a) Synthesis of a Compound Containing Benzene Ring in the Molecular Formula Thereof Among Glycoside Sulfonamide Compounds Represented by Formula II

18.7 g of intermediate compound B was weighed and dissolved in 30 ml of methanol, and 20.4 g of benzoyl hydrazine was added to react at room temperature for 24 hours while stirring. After the reaction, the solvent was dried by a rotary evaporator under reduced pressure, followed by separation by a liquid chromatography silica gel column, and elution and separation at room temperature with petroleum ether/ethyl acetate (at a ratio of 50/50 (v/v)) as a mobile phase at a flow rate of 5 ml/min, to obtain an intermediate compound C after purification.

A mixed solvent of methanol/glacial acetic acid at a volume ratio of 85:15 was prepared, and 2 g of intermediate compound C and 1.3 g of D-glucose were weighed and dissolved in 5 ml of the mixed solvent, which were stirred at a water bath environment at 45° C. for 12 hours. The product was dried by a rotary evaporator to spin-dry the solvent under reduced pressure, and then the product was separated by liquid chromatography silica gel column, followed by elution and separation at room temperature with dichloromethane/methanol (at a ratio of 92/8 (v/v)) as a mobile phase at a flow rate of 5 ml/min, to obtain a compound 2-1 after purification.

2 g of the intermediate compound C and 1.1 g of D-ribose were weighed and dissolved in 5 ml of the above methanol/glacial acetic acid mixed solvent, which were stirred for 12 hours in a water bath environment at 45°° C. The product was dried by a rotary evaporator to spin-dry the solvent under reduced pressure, and then the product was separated by liquid chromatography silica gel column, followed by elution and separation at room temperature with ethyl acetate as a mobile phase at a flow rate of 5 ml/min, to obtain a compound 2-2 after purification.

2 g of the intermediate compound C and 1.5 g of N-acetyl-D-glucosamine were weighed and dissolved in 5 ml of the above methanol/glacial acetic acid mixed solvent, which were stirred for 12 hours in a water bath environment at 45° C. The product was dried by a rotary evaporator to spin-dry the solvent under reduced pressure, and then the product was separated by liquid chromatography silica gel column, followed by elution and separation at room temperature with dichloromethane/methanol (at a ratio of 92/8 (v/v)) as a mobile phase at a flow rate of 5 ml/min, to obtain a compound 2-3 after purification.

### (b) Synthesis of a Compound Not Containing Benzene Ring in the Molecular Formula Thereof Among Glycoside Sulfonamide Compounds Represented by Formula II

18.7 g of the intermediate compound B was weighed and dissolved in 30 ml of methanol, to which 9.7 g of acetylhydrazine was added to react at room temperature for 24 hours while being stirring. After the reaction, the solvent was spin-dried by a rotary evaporator under reduced pressure, followed by separation by a liquid chromatography silica gel column, and elution and separation at room temperature with petroleum ether/ethyl acetate (at a ratio of 50/50 (v/v)) as a mobile phase at a flow rate of 5 ml/min, to obtain an intermediate compound D after purification.

A mixed solvent of methanol/glacial acetic acid at a volume ratio of 85:15 was prepared, and 2 g of the intermediate compound D and 1.3 g of D-glucose were weighed and dissolved in 5 ml of the mixed solvent, which were stirred at a water bath environment at 45° C. for 12 hours. The product was dried by a rotary evaporator to spin-dry the solvent under reduced pressure, and then the product was separated by liquid chromatography silica gel column, followed by elution and separation at room temperature with dichloromethane/methanol (at a ratio of 91/9 (v/v)) as a mobile phase at a flow rate of 5 ml/min, to obtain a compound 3-1 after purification.

2 g of the intermediate compound D and 1.4 g of D-ribose were weighed and dissolved in 5 ml of the above methanol/glacial acetic acid mixed solvent, which were stirred at a water bath environment at 45° C. for 12 hours. The product was dried by a rotary evaporator to spin-dry the solvent under reduced pressure, and then the product was separated by liquid chromatography silica gel column, followed by elution and separation at room temperature with ethyl acetate as a mobile phase at a flow rate of 5 ml/min, to obtain a compound 3-2 after purification.

2 g of the intermediate compound D and 1.5 g of N-acetyl-D-glucosamine were weighed and dissolved in 5 ml of the above methanol/glacial acetic acid mixed solvent, which were stirred at a water bath environment at 45° C. for 12 hours. The product was dried by a rotary evaporator to spin-dry the solvent under reduced pressure, and then the product was separated by liquid chromatography silica gel column, followed by elution and separation at room temperature with dichloromethane/methanol (at a ratio of 92/8 (v/v)) as a mobile phase at a flow rate of 5 ml/min, to obtain a compound 3-3 after purification.

### Preparation of Base Membrane

The base membrane was prepared by an immersion precipitation method. A casting solution contained 18 wt. % polysulfone and 2 wt. % polyethylene glycol 400, wherein the solvent was N,N-dimethylformamide. The solution was stirred at 60° C. for 6 hours and then put into an environment at 25° C. for constant-temperature defoaming for 12 hours. The defoamed casting solution was scraped on a polyester PET nonwoven fabric by a membrane scraper. The membrane had a thickness of 40 μm and was immersed in a pure water cold bath at 15° C. to be solidified into a membrane, followed by water washing, to obtain a base membrane of a polysulfone support layer having a porous structure.

### Preparation of a Water Phase Solution

10 g of piperazine was dissolved in 990 g of pure water, and the pH value of the solution was adjusted to 11 using 0.1 mol/L sodium hydroxide solution, to prepare a water phase solution.

### Preparation of an Oil Phase Solution

2 g of trimesoyl chloride was dissolved in 998 g of Isopar G solvent to prepare an oil phase solution.

### Preparation of Diethanolamine Solution

A diethanolamine solution was prepared according to 3 wt. % of diethanolamine, 2 wt. % of triethylamine, 4 wt. % of camphorsulfonic acid and the balance of pure water.

### Preparation of Crosslinking Agent Solution

1.25 g of an aqueous solution having a glutaraldehyde concentration of 40wt. % was dissolved in 100 g of pure water, which was diluted to 1000 g with water, and sulfuric acid was added dropwise to adjust the pH to 2.5-3.5.

### Preparation of Polyvinyl Alcohol Solution

10 g of polyvinyl alcohol powder, 1 g of an aqueous solution having a hydrochloric acid concentration of 37 wt. %, and 2 g of an aqueous solution having a glutaraldehyde concentration of 40 wt. % were weighed and put into 455 g of water, which were stirred at 90° C. for 0.5 hour and diluted with 500 g of pure water at room temperature, for later use.

### Comparative Example 1

The polysulfone base membrane prepared above was immersed in a pure water solution for 5 minutes to ensure the wetting of the membrane surface, then immersed in a water phase solution for 30 seconds, and after being taken out, the excess solution on the membrane surface was removed, and then the membrane was immersed in an oil phase solution to conduct interfacial polymerization reaction for 30 seconds to generate a polyamide functional layer, followed by heat treatment in an oven at 30°° C. for 2 minutes to further promote crosslinking, to obtain a primary nanofiltration membrane. The membrane was washed with hot water at 50° C. for 2 minutes and with cold water at 25° C. for 3 minutes, respectively, and coated with a protective layer of polyvinyl alcohol solution at 25°° C. for 10 seconds, and then dried at 85° C. for 1.5 minutes, to obtain a nanofiltration membrane.

### Comparative Example 2

Comparative Example 2 was carried out in the same way as Comparative Example 1, except that after the primary nanofiltration membrane was obtained, it was immersed in a diethanolamine solution at 50°° C. for 2 minutes and immersed in a crosslinking agent solution at room temperature for 2 minutes, respectively.

### Example 1

Example 1 was carried out in the same way as Comparative Example 2, except for the addition of 1 g of the above synthesized glycosylated sulfonamide compound 1-1 to the water phase solution.

### Comparative Example 3

Comparative Example 3 was carried out in the same way as Comparative Example 1, except for the addition of 1 g of the above synthesized glycosylated sulfonamide compound 1-1 to the water phase solution.

### Examples 2 to 13

Examples 2 to 13 were carried out in the same way as Example 1 except for replacing glycosylated sulfonamide compound 1-1 with the above synthesized glycosylated sulfonamide compound 1-2, 1-3, 1-4, 1-5, 1-6, 1-7, 2-1, 2-2, 2-3, 3-1, 3-2, or 3-3, respectively.

### Performance Characterization and Test Results

### (1) Permeation and Separation Performance Test

The nanofiltration membranes obtained in Comparative Examples 1 to 3 and Examples 1 to 13 were tested on a cross-flow membrane test bench, respectively. The test conditions were 0.1 g/L dye+1 g/L magnesium sulfate aqueous solution (the dyes were Congo red, methyl orange and acid fuchsin, respectively, and the mixed solutions of the three dyes and magnesium sulfate were tested during the test), an operating pressure of 70 psi, a temperature of 25° C., and a pH value of 7. The stable test time was 40 minutes.

The test results are shown in Table 1 below.

TABLE 1

| | | | | | | Removal | |
|---|---|---|---|---|---|---|---|
| | | | | Removal rate | Removal rate | rate of | Removal |
| Serial | | | Permeation flux | of magnesium | of Congo red | methyl | rate of acid |
| number | Additive | Post-treatment | (L · m⁻² · h⁻¹ · MPa⁻¹) | sulfate (%) | (%) | orange (%) | fuchsin (%) |
| Comparative | No | No | 53.21 | 98.12 | 99.9 | 99.9 | 99.9 |
| Example 1 | | | | | | | |
| Comparative | No | Yes | 49.35 | 98.24 | 99.9 | 99.9 | 99.9 |
| Example 2 | | | | | | | |
| Comparative | Compound | No | 116.9 | 20.08 | 92.4 | 69.5 | 83.1 |
| Example 3 | 1-1 | | | | | | |
| Example 1 | Compound | Yes | 98.26 | 28.31 | 99.2 | 88.6 | 93.7 |
| | 1-1 | | | | | | |
| Example 2 | Compound | Yes | 96.26 | 28.74 | 99.5 | 89.1 | 92.9 |
| | 1-2 | | | | | | |
| Example 3 | Compound | Yes | 102.5 | 24.61 | 99.0 | 85.1 | 92.6 |
| | 1-3 | | | | | | |
| Example 4 | Compound | Yes | 88.15 | 34.93 | 99.6 | 90.3 | 94.8 |
| | 1-4 | | | | | | |
| Example 5 | Compound | Yes | 101.2 | 22.18 | 98.9 | 84.2 | 91.2 |
| | 1-5 | | | | | | |
| Example 6 | Compound | Yes | 92.56 | 30.21 | 99.1 | 86.1 | 92.5 |
| | 1-6 | | | | | | |
| Example 7 | Compound | Yes | 87.15 | 33.15 | 99.4 | 87.8 | 92.2 |
| | 1-7 | | | | | | |
| Example 8 | Compound | Yes | 110.2 | 20.91 | 98.6 | 82.6 | 89.9 |
| | 2-1 | | | | | | |
| Example 9 | Compound | Yes | 117.3 | 22.73 | 98.2 | 85.4 | 91.2 |
| | 2-2 | | | | | | |
| Example 10 | Compound | Yes | 109.7 | 21.95 | 98.8 | 84.4 | 90.9 |
| | 2-3 | | | | | | |
| Example 11 | Compound | Yes | 91.65 | 28.14 | 99.1 | 89.7 | 94.5 |
| | 3-1 | | | | | | |
| Example 12 | Compound | Yes | 98.24 | 27.76 | 99.3 | 88.4 | 93.4 |
| | 3-2 | | | | | | |
| Example 13 | Compound | Yes | 88.17 | 30.18 | 99.0 | 89.1 | 92.7 |
| | 3-3 | | | | | | |

According to the results of Comparative Examples 1-2, because no glycosylated sulfonamide compound was added, the membranes obtained had little difference in permeation flux and selective separation of organic dye molecules and inorganic salt ions, regardless of hydroxylation and crosslinking treatment, according to the results of Comparative Example 3 and Examples 1 to 3, the permeation flux of the prepared nanofiltration membranes was significantly improved by adding a glycosylated sulfonamide compound as an additive to the water phase solution to participate in the interfacial polymerization reaction; meanwhile, the selectivity of the membranes to organic dye molecules and inorganic salt ions was increased, which is beneficial to the selective separation of organic dye molecules and inorganic salt ions and may be effectively applied to wastewater treatment in dye industry.

Besides, during the test, it was observed that in Comparative Example 3, the selective separation performance gradually decreased during the stable test time, while in Examples 1 to 13, no obvious decrease in the selective separation performance was observed. In view of the comparison between Comparative Example 3 and Examples 1 to 13, for the nanofiltration membrane added with a glycosylated sulfonamide compound, hydroxylation treatment and crosslinking treatment is capable of effectively fixing the additive—the glycosylated sulfonamide compound, which ensures that the membrane does not have large defects that will lead to the reduction of separation performance.

### (2) Antibacterial Property Test

Preparation of a culture medium: 5.0 g of beef extract, 10.0 g of peptone and 5.0 g NaCl were dissolved in 1 L of pure water, stirred evenly, and the pH value was adjusted to neutral. Then, the mixture was sterilized in an autoclave at 120° C. for 20 minutes to obtain a liquid culture medium. 18 g agar was added to the liquid culture medium and sterilized to obtain a solid culture medium.

The antibacterial property of the nanofiltration membrane was studied by colony counting method of Escherichia coli (ATCC: 25922) and Staphylococcus aureus (CMCC(B): 26003).

At first, bacteria were cultured in a liquid culture medium at 37° C. for 24 hours, and the culture medium with bacteria was continuously shaken, centrifuged to obtain bacterial cells, which were diluted with PBS. Next, the membrane sample having an area of 3 cm×3 cm was immersed in 15 mL of the bacterial suspension and taken out after 15 hours. Then, the bacterial suspension diluted to 0.1 mL was evenly coated on the solid culture medium, and then cultured at 37° C. for 24 hours. Finally, the number of colonies on the solid culture medium was counted. All operations were carried out in a sterile environment. The number of growing bacteria was calculated according to the following formula:

$$ABA ( \% ) = \frac{( Np - Ns )}{Np} \times 100 \%$$

In this formula, ABA is the antibacterial activity;
Np is the number of colonies growing on the polysulfone base membrane;
Ns is the number of colonies growing on the nanofiltration membrane;

The nanofiltration membranes in Comparative Example 2 and Examples 1, 4, 7, 10 and 11 were subject to antibacterial property test. The test results are shown in Table 2:

TABLE 2

| | | Antibacterial | Antibacterial |
|---|---|---|---|
| | | activity to | activity to |
| | | Escherichia | Staphylococcus |
| Serial number | Additive | coli (%) | aureus (%) |
| Comparative | No | 9.25 | 8.73 |
| Example 2 | | | |
| Example 1 | Compound 1-1 | 90.61 | 88.15 |
| Example 4 | Compound 1-4 | 91.22 | 89.81 |
| Example 7 | Compound 1-7 | 89.64 | 90.26 |
| Example 10 | Compound 2-3 | 87.68 | 88.20 |
| Example 11 | Compound 3-1 | 91.31 | 89.95 |

In view of the results in Table 2, the membranes containing the additive—a glycosylated sulfonamide compound have excellent antibacterial activity, which is beneficial to effectively alleviate the biological pollution on the membrane surface during the operation of the membrane.

### INDUSTRIAL AVAILABILITY

The present disclosure provides a preparation method of a nanofiltration membrane, which is simple and easy to operate. The nanofiltration membrane prepared by the preparation method according to the present disclosure has a water flux as high as 80-120 L/(m²/h), the removal rates of Congo red, methyl orange and acid fuchsin may reach 99%, 82-90% and 90-95%, respectively, and the removal rate of magnesium sulfate may be adjusted to 30%, thereby realizing selective separation of organic dye molecules and inorganic salts, and the nanofiltration membrane further has an excellent antibacterial performance, which effectively relieves microbial pollution on the surface of the membrane during operation. The nanofiltration membrane provided by the present disclosure may be applied to effective selective separation in the fields of water treatment, dyes, biochemistry, food, environmental protection and the like.

What is claimed is:

1. A preparation method for a nanofiltration membrane, comprising the following steps:
preparing a casting solution, and curing the casting solution on a reinforcement material to form a base membrane, wherein the casting solution contains a polymer and a solvent;
contacting the base membrane with a water phase solution and an oil phase solution in turn to perform an interfacial polymerization reaction on the base membrane to form a polyamide functional layer, wherein the water phase solution contains a water phase monomer and an additive, the additive is a glycosylated sulfonamide compound, and the oil phase solution contains an oil phase monomer; and
performing post-treatment to obtain the nanofiltration membrane, wherein the post-treatment comprises hydroxylation treatment and crosslinking treatment.

2. The preparation method according to claim 1, wherein the polymer is at least one selected from the group consisting of polysulfone, polyethersulfone, sulfonated polyethersulfone, polyimide, polyvinylidene fluoride, polyacrylonitrile, polypropylene and polyvinyl chloride.

3. The preparation method according to claim 1, wherein the glycosylated sulfonamide compound is obtained by glycosylation reaction between a saccharide compound and a compound containing a sulfonamide group.

4. The preparation method according to claim 3, wherein the saccharide compound is at least one selected from the group consisting of D-glucose, N-aryl glycoside, lactose, galactose, N-acetyl-D-glucosamine, arabinose, N-acetyl-D-galactosamine, D-ribose, L-rhamnose, xylose, mannose and tingji.

5. The preparation method according to claim 3, wherein the compound containing a sulfonamide group is at least one selected from the group consisting of compounds represented by the following formula I and compounds represented by the following formula II: 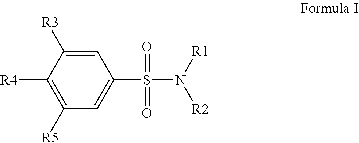
in formula I, each of R1 and R2 are independently at least one selected from the group consisting of H, hydrocarbon group having 1 to 5 carbon atoms, amino group and cyano group, each of R3, R4 and R5 are independently at least one selected from the group consisting of H, amino group, imino group and hydroxyl group, and at least one of R3, R4 and R5 is an amino group; 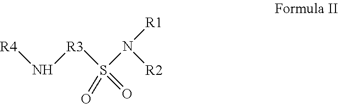
in formula II, each of R1 and R2 are independently hydrocarbon groups having 1 to 10 carbon atoms, which optionally contain at least one selected from the group consisting of amino group, cyano group, carboxyl group, double bond and ethynyl group; R3 is a hydrocarbon group having 1 to 5 carbon atoms; R4 is H or hydrocarbon group having 1 to 10 carbon atoms, the hydrocarbon group having 1 to 10 carbon atoms optionally containing at least one selected from the group consisting of hydroxyl group, carboxyl group, ketonic group, ether bond, carbonyl group, imino group, acyl group and phenyl group.

6. The preparation method according to claim 1, wherein the water phase monomer is at least one selected from the group consisting of piperazine, 2-methylpiperazine, polyethyleneimine, m-phenylenediamine, p-phenylenediamine, o-phenylenediamine and benzene-1,3,5-triamine.

7. The preparation method according to claim 1, wherein the oil phase monomer is at least one selected from the group consisting of trimesoyl chloride, cyanuric chloride, dansyl chloride, isophthaloyl chloride, terephthaloyl chloride, phthaloyl chloride and biphenyl tetracarbonylchloride.

8. The preparation method according to claim 1, wherein the hydroxylation treatment is carried out in a solution containing an alcohol amine substance.

9. The preparation method according to claim 1, wherein the crosslinking treatment is carried out in a solution containing a crosslinking agent which is a dialdehyde compound having 2 to 6 carbon atoms.

10. A nanofiltration membrane prepared by the preparation method according claim 1.

11. The preparation method according to claim 2, wherein the glycosylated sulfonamide compound is obtained by glycosylation reaction between a saccharide compound and a compound containing a sulfonamide group.

12. The preparation method according to claim 2, wherein the water phase monomer is at least one selected from the group consisting of piperazine, 2-methylpiperazine, polyethyleneimine, m-phenylenediamine, p-phenylenediamine, o-phenylenediamine and benzene-1,3,5-triamine.

13. The preparation method according to claim 2, wherein the oil phase monomer is at least one selected from the group consisting of trimesoyl chloride, cyanuric chloride, dansyl chloride, isophthaloyl chloride, terephthaloyl chloride, phthaloyl chloride and biphenyl tetracarbonylchloride.

14. The preparation method according to claim 2, wherein the hydroxylation treatment is carried out in a solution containing an alcohol amine substance.

15. The preparation method according to claim 2, wherein the crosslinking treatment is carried out in a solution containing a crosslinking agent which is a dialdehyde compound having 2 to 6 carbon atoms.

16. The preparation method according to claim 3, wherein the mass percentage concentration of the glycosylated sulfonamide compound is 0.001-1.0 wt. % based on the total mass of the water phase solution.

17. The preparation method according to claim 6, wherein the mass percentage concentration of the water phase monomer is 0.1-3.0 wt. % based on the total mass of the water phase solution.

18. The preparation method according to claim 7, wherein the mass percentage concentration of the oil phase monomer is 0.05-1.0 wt. % based on the total mass of the oil phase solution.

19. The preparation method according to claim 8, wherein the alcohol amine substance is at least one selected from the group consisting of diethanolamine and triethanolamine, wherein the mass percentage concentration of the alcohol amine substance is 0.5-5.0 wt. % based on the total mass of the solution containing the alcohol amine substance.

20. The preparation method according to claim 9, wherein the mass percentage concentration of the crosslinking agent is 0.01-0.5 wt. % based on the total mass of the solution containing the crosslinking agent.
